(19) United States
(12) Patent Application Publication
(10) Pub. No.: US 2019/0091563 A1
(43) Pub. Date: Mar. 28, 2019

(54) Electronic Motion Sensing Devices and Method of Operating Same

(71) Applicant: DigiBit, LLC, Shelby Township, MI (US)

(72) Inventors: Colt Correa, Shelby Township, MI (US); Muhammad Uzair, Karachi (PK)

(73) Assignee: DigiBit, LLC, Shelby Township, MI (US)

(21) Appl. No.: 16/157,029

(22) Filed: Oct. 10, 2018

Related U.S. Application Data
(63) Continuation-in-part of application No. 15/238,307, filed on Aug. 16, 2016.

(51) Int. Cl. A63F 13/24

(52) U.S. Cl. CPC A63F 13/24

(57) ABSTRACT

The invention relate to a set of methods that can be used in portable electronic or wearable motion sensing devices or game controller assemblies, to calculate a plurality of motion parameters. Simplified binary values for motion information is also provided as well as a method to determine the orientation of the device relative to a body part that it is attached to. Embodiments of the invention can be wearable, e.g., worn on the human body, handheld in a game assembly, handheld in a toy or more generally attached to any movable body. The invention also provides a method for observers of a player of a video game or user of a computer application to combine camera data from the observer's smart device with the game play or application screen of the player or user's smart device on the observer's smart device.

This patent application is a continuation-in-part patent application of a U.S. patent application Ser. No. 15/238,307, filed Aug. 16, 2016, the disclosure of which is expressly incorporated herein by reference.

### BACKGROUND ART

### 1. Field of the Invention

The invention relates to portable electronic motion sensing devices. More particularly, the invention relates to methods for calculating motion or position data for the portable electronic motion sensing devices. A method to combine images of computer game play or an application screen along with images or video game player or user of the application on the observers smart device is provided.

### 2. Description of the Related Art

Very few games or gaming devices for children are designed to make the participants move about. Those that may encourage activity are not social because they are typically too big to move easily. In a day and age where the lure of electronics makes it difficult for a child to be active and social at the same time.

One example of a product that attempts to mimic real life activity is the Nintendo Wii console. It has a game wand and a console that is attached to a monitor, such as television. One or two players can play at a time. While the Nintendo Wii encourages the players to be active, the limitations of the system include its inability to work without a monitor and, as such is not very mobile to work where the children are playing. Further, the wand has limited accuracy as to the movements being made by the player allowing the player to mimic the necessary movement with little real movement.

### SUMMARY OF THE INVENTION

A method utilizes an electronic motion sensing device to calculate motion using motion data collected by a motion sensor. The method begins with the step of collecting the motion data using the motion sensor. Output data is then calculated from the motion data. Combined data is created by combining the output data with the motion data. The combined data is compared to known data patterns. It is then determined whether a trigger event has occurred. If so, a frame of reference is set for calculating the output data to be used by the electronic motion sensing device after the trigger event occurs.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a top view of one embodiment of the invention;

FIG. 2 is a bottom view of the invention with a bottom plate removed;

FIG. 3 is a side view of the invention;

FIG. 4 is a top view of an alternative embodiment of the invention attached to an article of clothing;

FIG. 5 is a schematic view of the alternative embodiment of the invention showing various electronic components;

FIG. 6 is a logic chart of an operation of the invention;

FIGS. 7 through 10 shows various screenshots of games as viewed on a smart device paired with one embodiment of the invention; and

FIGS. 11a and 11b are side-by-side illustrations showing the invention operating in a virtual reality-styled game environment.

FIG. 12 is a top view of a second embodiment of the invention strapped to a user's hand;

FIG. 13 is a top view of the second embodiment of the invention secured to a user's shoe;

FIG. 14 is a perspective view of a third embodiment of the invention embedded in a host device with an external computing device secured to the host device;

FIGS. 15a-15d are graphs of data relating to motion of an electronic motion sensing device;

FIG. 16 is a logic chart of one embodiment of the inventive method;

FIGS. 17a and 17b are top views of the second embodiment of the electronic motion sensing device;

FIG. 17c is a side view of the second embodiment;

FIG. 17d is a front view of the second embodiment;

FIGS. 18a through 18b represent an external computing device showing a screen while communicating with the invention and a player using the combination of the external computing device and the invention, respectively;

FIGS. 19a through 19b represent an external computing device showing a screen of a game at a later state in time while communicating with the invention and a player using the combination of the external computing device and the invention, respectively;

FIGS. 20a through 20b represent an external computing device showing a screen of a game at an even later state in time while communicating with the invention and a player using the combination of the external computing device and the invention, respectively;

FIGS. 21a and 21b is a top view of one embodiment of the invention secured to a wrist of a user;

FIG. 22 is a logic chart of a method to orient one embodiment of the invention;

FIG. 23 is an exploded view of a second inventive method being used with first and second external computing devices;

FIG. 24 is a block diagram of two external computing devices operating according to the inventive method shown in FIGS. 25a and 25b; and

FIGS. 25a and 25b are logic charts of an inventive method for superimposing an image over another during a game situation.

### DETAILED DESCRIPTION OF THE PREFERRED EMBODIMENTS

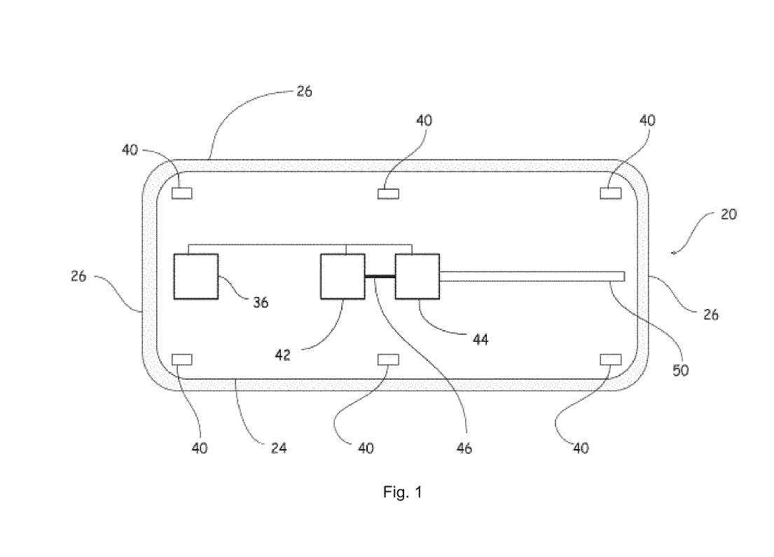

Referring to FIG. 1, one embodiment of the inventive assembly is generally indicated at 20. The assembly 20 is a game communication assembly or device 20. Generally, the game communication assembly 20 is of unitary construction and includes a housing 22 that covers all of the game communication assembly 20. The housing 22 is transparent allowing one to view all of the components inside the housing 22. It should be appreciated by those skilled in the art that the housing 22 may be translucent or opaque, depending on the desired aesthetic for a particular unit.

Inside the housing 22, the game communication assembly 20 includes a printed circuit board (PCB) 24. The PCB 24 is the structure to which all of the electronic components of the game communication assembly 20 will be connected. The PCB 24 extends out to the edges of the housing 22 and partially held in place by the side walls 26 that form a portion of the housing 22. Other structures formed with the housing 22 to hold the PCB 24 in place are not shown. While the invention is shown with a single PCB 24, one skilled in the art should appreciate that some configurations may include more than one PCB 24.

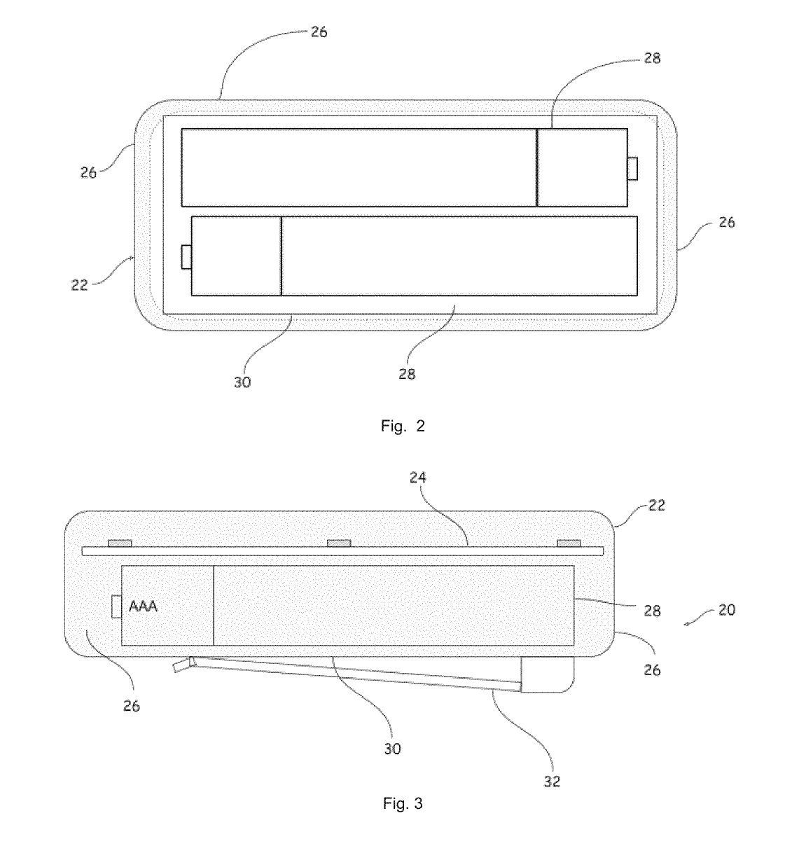

Referring to FIGS. 2 and 3, the game communication assembly 20 includes a power source 28 to power the components within the housing 22. In the embodiment shown, two AAA batteries 28 are housed within the housing 22 and have electrical connections to provide electrical power to the components mounted to the PCB 24. The batteries 28 may be a different size and they may be rechargeable. A charging port (not shown) may allow the batteries 28 (or cells) to be charged in situ.

The housing 22 includes a removable panel 30 to access the batteries 28 and the PCB 24. A chord 34 may extend out of the housing 22. The chord 34 may include a string of LEDs 35 that emit light in a programmed manner based on the mode in which the game communication assembly 20 is operating. The chord 34 may serve as a shoelace for a shoe (not shown). It should be appreciated by those skilled in the art that the game communication assembly 20 could also be embedded in other articles of clothing such as shoes, gloves, hats, shirts, pants and the like.

The housing 22 also includes a fastener 32 to fasten the game communication assembly 20 to an article of clothing 38, best seen in FIGS. 11a and 11b. It should be appreciated by those skilled in the art that the fastener may be a clip as shown, or any other device suitable for securing the game communication assembly 20 to the article of clothing 38, which may also be a shoe, a sock, a hat, a visor, a shirt, a belt and the like.

Referring back to FIG. 1, the PCB 24 is shown to have a voltage regulator 36. The voltage regulator 36 receives power from the power source 28 and provides power to the rest of the components on the PCB 24. LEDs 40 are illuminated based on the programming of the game communication assembly 20 and the game played by the user, both of which will be discussed in greater detail subsequently. In one embodiment, the voltage regulator 36 is produced by myRata, Inc. having part number LXDC2HN33A. The LEDs 40 may emit a single wavelength of light or multiple ranges of wavelengths and will be programmed appropriately for proper illumination.

A sensor 42 is electrically connected to the voltage regulator 36. The sensor 42 is a motion sensing device that may include any of the following: an accelerometer, a gyroscope and a magnetometer. The sensor 42 is able to determine how the game communication assembly 20 is moving, where it is in space and how fast it is going. In one embodiment, the motion sensing device 42 is an LSM9DS0TR 3D accelerometer, 3D gyroscope, 3D magnetometer produced by ST Microelectronics™.

Also receiving power from the voltage regulator 36 is an electronic control unit 44. The electronic control unit (ECU) 44 is electrically connected to the voltage regulator 36 and the motion sensing device 42. The ECU 44 communicates with the motion sensing device 42 using an I²C system 46. The ECU 44 may be a Nordic nrf52 System On Chip (SOC) that includes a 32-bit ARM processor and is capable of both ANT and BLE communications due to it having a transceiving unit built-in. ANT communications is a low power wireless technology that reduces the requirements for devices to communicate with each other. BLE (or Bluetooth® 4) is a low power version of Bluetooth®. ANT communications enable multiple game communication assemblies 20 to communicate with each other automatically when the game communication assemblies 20 are moved within the radio frequency range of each other. Connections or channels of data can be established using ANT communications without user input. BLE (or Bluetooth® 4) or standard Bluetooth® generally requires a user to pair devices together. In the present embodiment, BLE (or Bluetooth® 4) or standard Bluetooth® is used in the invention 20 to additionally communicate with a smart device because nearly all smart devices on the market such as iPhones, iPADS, and Android devices have BLE (or Bluetooth® 4) or standard Bluetooth® communications capability. And pairing a game communication assembly 20 with a smart device presumably need only be done once.

An RF antenna 50 is electrically connected to the ECU 44 and is used to receive and transmit signals to and from the ECU 44. The RF antenna 50 is shown as a single trace printed on the PCB 24. The RF antenna 50 may be located anywhere within the housing 22 to support convenient manufacture and/or maximize the gain of the RF antenna 50.

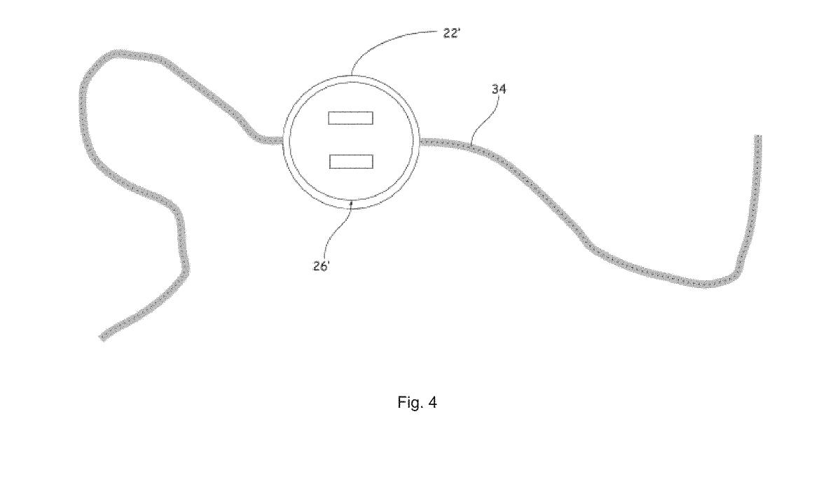

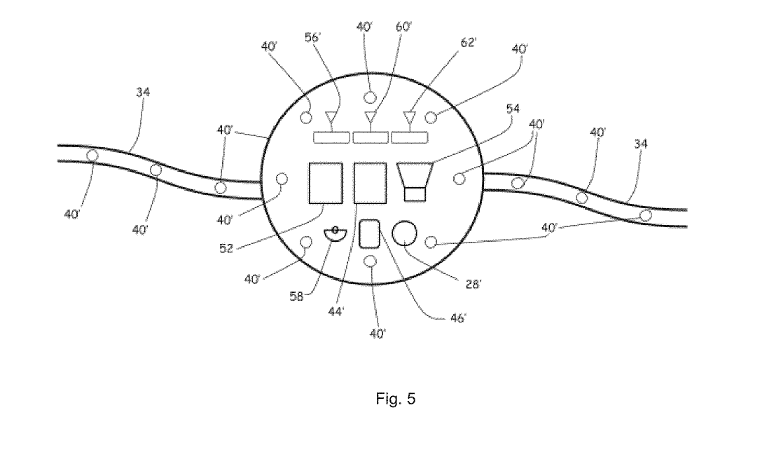

Referring to FIGS. 4 and 5, an alternative embodiment of the game communication assembly 20′ is generally shown with like primed numerals representing similar elements as in the embodiment shown in FIGS. 1 through 3. This embodiment 20′ differs from the prior embodiment 20 principally in its shape. Instead of four sidewalls 26, the housing 22 has a single cylindrical shaped sidewall 26′. The circular cylindrical shape of the sidewall 26′ gives the housing 22′ the shape of a puck. The puck-shaped housing 22′ is conducive to it being secured to various articles of clothing easier than others. It can also be held in a user's hand if that is desired, whereby the chord 34 extending out of the housing 22 can be used to fasten or tie the game communication assembly 20 to the hands, ankles, feet, or any other body part.

In this alternative embodiment, persistent memory 52 is used to store programs, track game results and store preference of the user. A speaker 54 is capable of producing any type of noise, sound, or voice that is required to assist the user in playing the chosen game. An RF antenna 56 provides RF communications using ANT protocol allows the game communication assembly 20′ to communicate between peer game communication assemblies 20, 20′ nearby. A haptic feedback device 58 may produce a vibration or other type of motion to allow the user to feel when the game communication assembly 20′ is signaling the user. Likewise, the game communication assembly 20′ may generate a sound from the speaker 54 to alert the user. A second RF antenna 60 for BLE provides communications for the host game communication assemblies 20′. A WiFi antenna 62 provides additional communication capabilities between multiple host game communication assemblies 20′. All of these devices that are used to communicate with smart devices and other game communications assemblies 20, 20′ are collectively referred to as a transceiving unit.

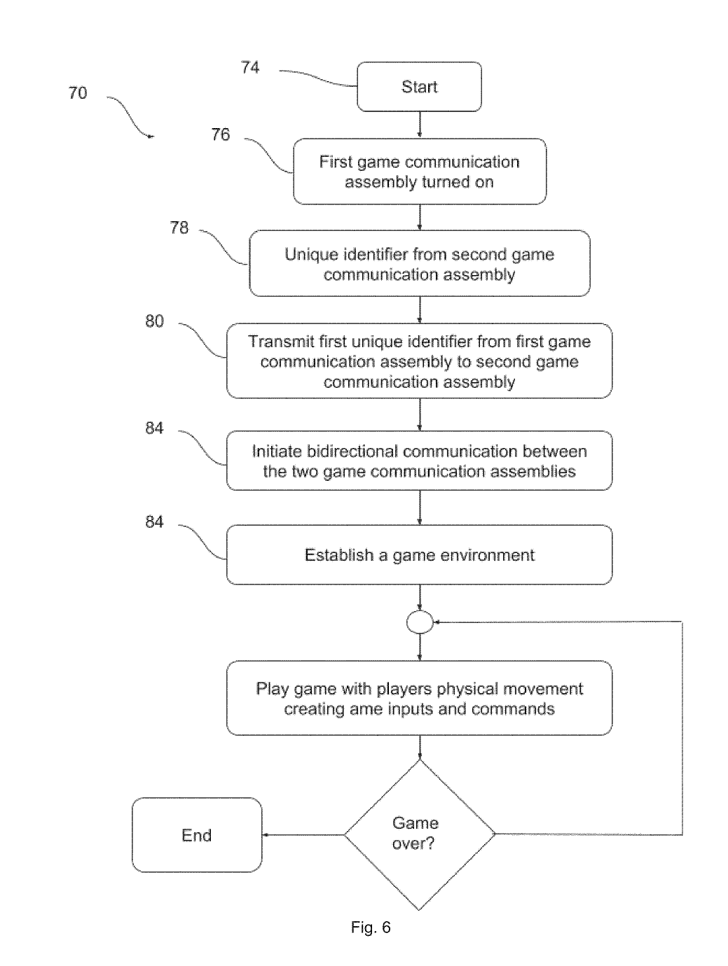

Referring now to FIG. 6, a method of operation is generally indicated at 70. The method 70 coordinates a game for a plurality of players 72 (shown in subsequent Figures) that are wearing at least one game communication assembly 20, 20′. In the Figures, each user is shown to be wearing a game communication assembly 20, 20′ on each shoe.

The method 70 begins at 74. A first game communication assembly 20, 20′ is turned on at 76. A unique identifier is received from a second game communication assembly 20, 20′ when one of the plurality of players 72 is in range of the first game communication assembly 20, 20′ at 78. The first game communication assembly 20,20′ then transmits it first unique identifier to the second game communication assembly at 80 to initiate bidirectional communication at 82. A game environment is established for the first and second game communication assemblies 20, 20′ for which any number of a plurality of players may join to play at 84. The game is commenced and played with each of the users or players 72 using body movements to create inputs and/or game commands at 86. It is then determined at 90 whether the game is over. If not, the game loops back at 92 and continues to receive inputs and commands from players 72 that were created out of the physical motion or movement of the players 72 to progress the game. If not, the game method 70 ends at 94.

As stated above, all the while a game is being played, new players 72 that come into a location where the game is being played may join the game, provided there is room for the player 72 within the game and it makes sense to add a player 72 at that juncture of the game.

For the games to work, the input values and the commands form one of the plurality of game communication assemblies 20, 20′ must be synced across all of the game communication assemblies 20, 20′ in real time such that any one of the plurality of players 72 may leave the game without affecting any remaining players 72 of the plurality of players 72 from completing the game. Not only is it important for completing the game, it is important for all of the plurality of players 72 to be on the same page and playing the same game at the same time. As stated above, it is important to sync all of the game communication assemblies 20, 20′ in a game so that the departure of one of the game communication assemblies 20, 20′ will minimally affect the game currently being played.

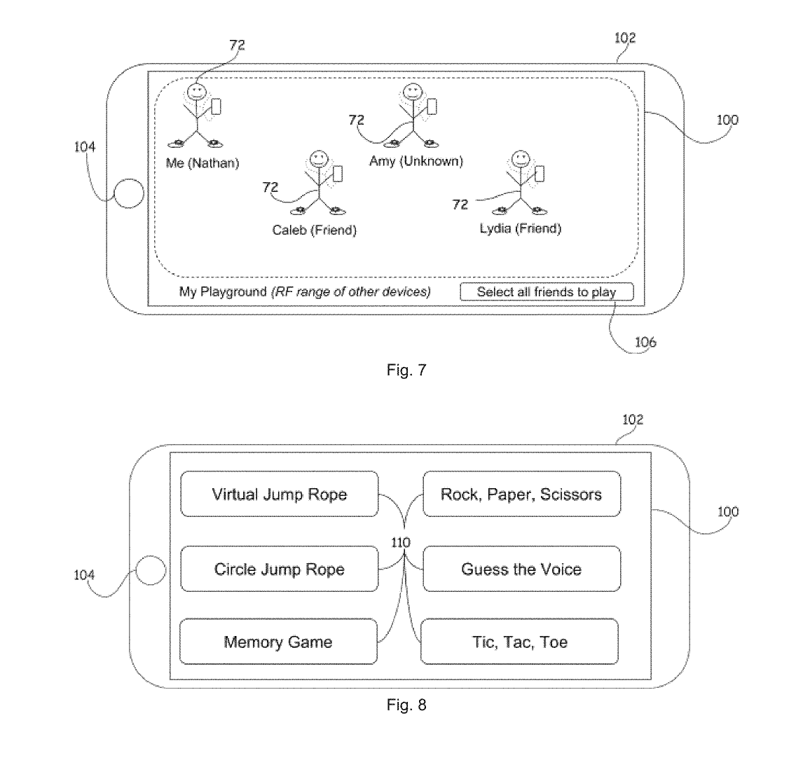

One aspect of the invention that is important is the ability to pair the game communication assemblies 20, 20′ with a smart device. Referring to FIGS. 7 through 10, an example of a game is illustrated as seen on a screen 100 of a smart device 102. The smart device 102 is shown to have a home button 104, which is presented for illustrative purposes only.

In FIG. 7, a group of players are found to be in such close proximity that they can start a game together. The proximity closeness will depend on the various technologies, but the ANT technology has a general limit of 50 meters. Once the game communication assemblies 20, 20′ are identified, those that wish to play can be selected using the selection button 106.

Once the set of players 72 have been identified, a game can be selected. Using the smart device 102, a number of game options can be listed. Referring to FIG. 8, a selection from a listing of games 110 can be made. It should be appreciated by those skilled in the art that the list of games may include any number of games. If needed, an instruction set for the games may be provided (not shown in the Figures).

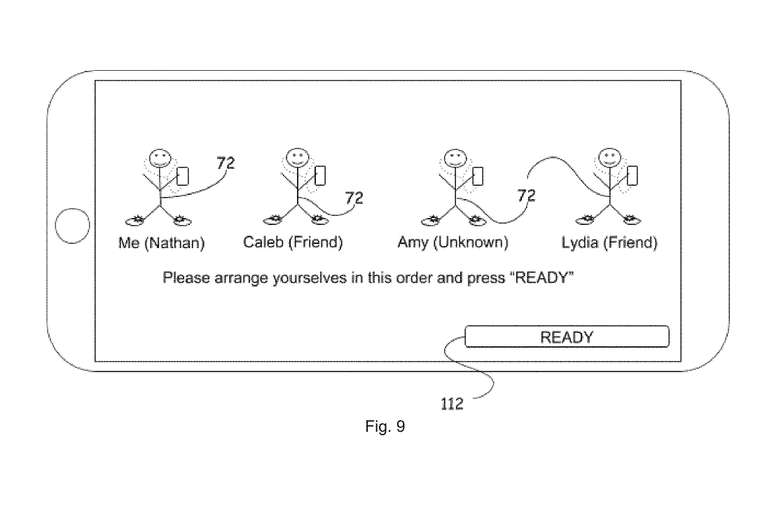

Referring to FIG. 9, the game communication assembly 20, 20′ may require the players 72 to configure themselves in a particular order. If this is required, it will be shown on the smart device screen as shown, for example, in FIG. 9. Once the players 72 are in the correct order, one of the players 72 can press the “READY” button 112.

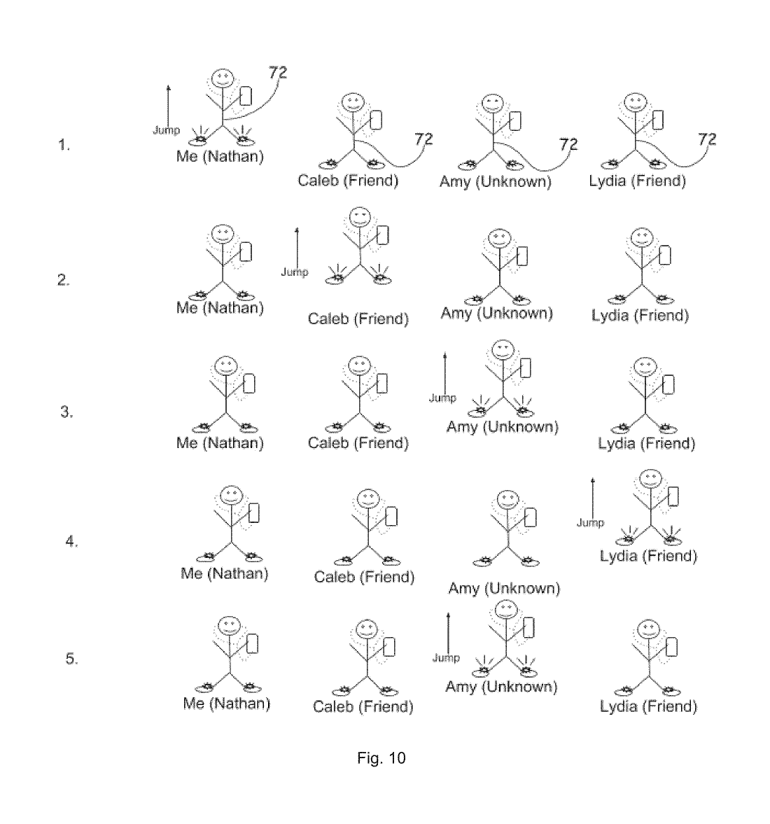

The circle jump rope game is illustrated in FIG. 10 with each of the players 72 being instructed when to jump. The game communication assemblies 20, 20′ may vibrate using the haptic feedback device, it may illuminate the LEDs 40, 40′ or it may generate a noise through the speaker 59. The game communication assembly 20, 20′ that signals its user to jump will use the motion sensor device 42 to confirm that the player 72 moved within a predefined time period. If so, the player 72 continues. If not, the player 72 that did not move will be penalized or will be out of the game.

Referring now to FIGS. 11a and 11b, side-by-side views of a pseudo-virtual reality game as seen on a smart device and as seen in real life are shown, respectively. For purposes of this discussion, pseudo-virtual reality is a game involving one or more players were the movement and actions of the players and their respective appendages are incorporated into the game. The pseudo-virtual reality game may or may not impose itself onto the surroundings of the player(s).

Referring specifically to FIG. 11a, a player 72 is represented in the smart device scene depiction 115 as a character 114. The game being played requires the player 113 (seen in FIG. 11b), through the character 114, to interact with a game-generated opponent 118. The player 113 controls the movement of the character 114 and watches the scene unfold on his or her smart device 116, shown to be held in the left hand of the player 113. The player 113 is shown to be wearing to game communication devices 20, 20′; one 20, 20′ on his right hand and another 20, 20′ on his right shoe 122. The game communication devices 20, 20′ worn by the player 113 work in concert to create the movements of the character 114 as it interacts with the game-generated opponent 118.

Referring now to FIG. 11b, the player 113 is shown with the game-generated opponent shown in phantom 119 for reference. It should be understood that other placements and configuration of the smart device and game communications assembly can exist. For example, the user 113 could, with the aid of a virtual reality headset device, wear the smart device on the head and hold a game communication assembly 20, 20′ in each hand. In current versions of some games, the character 114 is controlled with swipe and tapping motions on the screen of the smart device 116. The invention can enhance this game play, increasing the exercise of the user 113 playing the game by replacing the swipe and tapping motions with real hand, feet or other body part motions or gestures. When game communication assembly 20, 20′ attached to an article of clothing, a body part of held in the hand, it can communicate motion information to control the user's character 114. Additionally, the game communication assembly 20, 20′ has the ability to communicate this motion information with other game communication assemblies 20, 20′ attached to another player 120 of the game within RF proximity so that more than one user can share real time motion information in one game. Using the ANT protocol, the game communication assembly 20, 20′ can share motion information with other game communication assemblies and multiple smart devices involved in gameplay with latencies less than the existing method of using the internet connectivity of the smart device to enable multiple players to interact in one fight scene. The game communications assembly 20, 20′ also provides the additional benefit of removing the need for or WiFi communications to enable multiplayer gameplay.

A second embodiment of the invention relates to an electronic motion sensing device 200. The electronic motion sensing device 200 may be worn by a human 202 or incorporated into a device 204 designed to be moved. A non-exhaustive list of devices 204 that may include the electronic motion sensing device 200 include, but is not limited to, game pieces, toy blasters, toy guns, wands, medical equipment, prostheses, robots, manufacturing equipment, and the like.

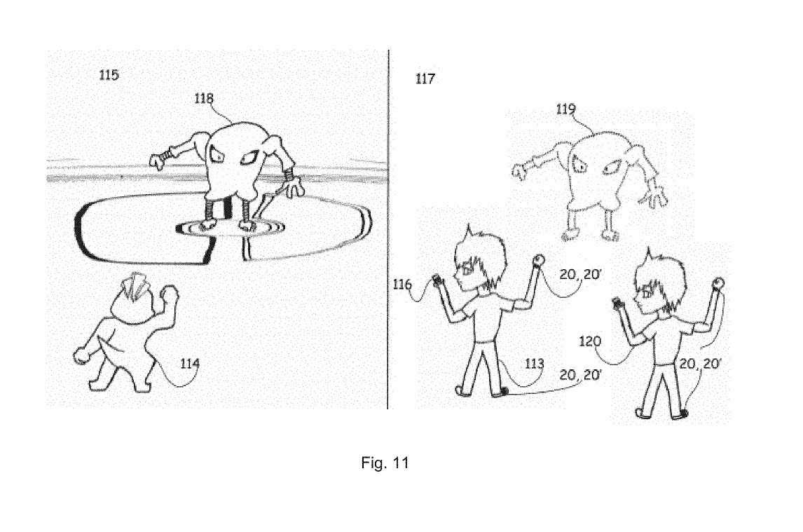

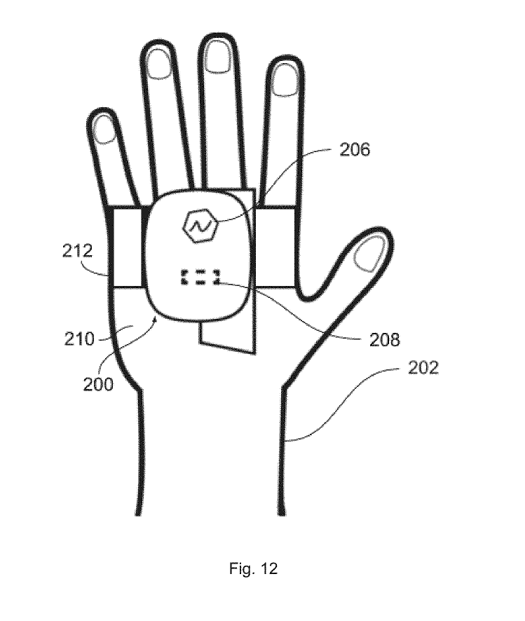

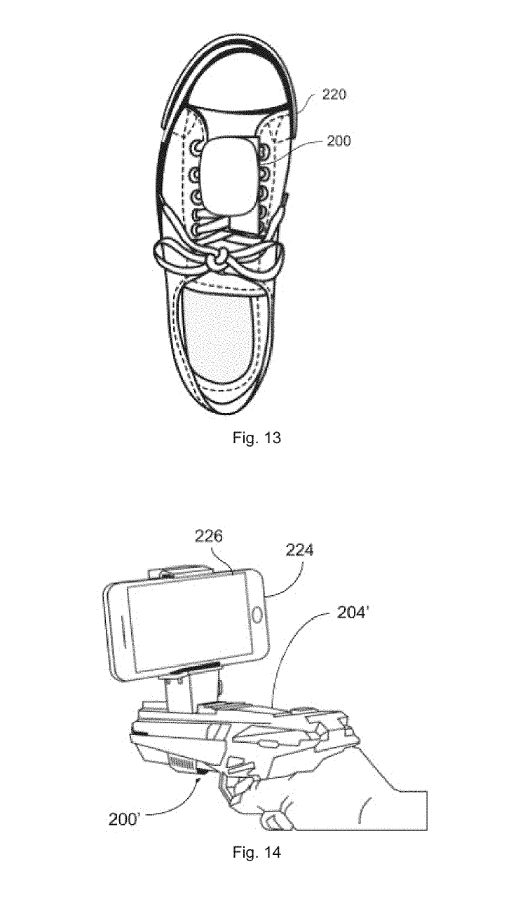

Referring to FIG. 12, a second embodiment of the invention, an electronic motion sensing device, is generally shown at 200. The electronic motion sensing device 200 creates sensor data 206 correlating to the motion of its host human 202 or device 204 (collectively referred to as a “host 202, 204”), and creates a motion signal 208 encapsulating the collected sensor data 206. The sensor data 206 is combined, manipulated, filtered or otherwise transformed into useful information provided in the form of linear displacement, linear velocity, linear acceleration, linear jerk, angular displacement, angular velocity, angular acceleration, angular jerk and macro binary movement states, such as up and down, forward and backward, right and left turns, right and left tilts, forward and back tilts. Many of these parameters are directional and can be divided into three-dimensional components. A common method to represent this motion data is through the three-dimensional cartesian coordinate system using X, Y and Z variables, in combination with the three-dimensional system utilizing the euler angular values of yaw, pitch and roll. The combination of a cartesian three-dimensional (3D) vector space of X, Y and Z along with three euler angles of yaw, pitch and roll is hereinafter referred to as a frame of reference. Another method of representing motion data is through the use of quaternions having a four-dimensional vector space; a method having an advantage of not being subject to gimbal lock where any 2 of the 3 axes are at a parallel configuration and thus a loss of one degree of freedom as is well known in the art. For the purpose of simplicity, euler rotations with cartesian 3D space are used to describe the invention.

Generally, 3D linear velocity and displacement are denoted herein with cartesian coordinates, X for in and out, Y for back and forth, and Z for up and down. By way of example, if the electronic motion sensing device 200 is worn on the back of a hand 210 using a securing band 212, positive X would be in the direction of the fingers 214, positive Y would be perpendicular to the fingers 214 and parallel to the ground or earth 216 and positive Z would be in the opposite direction of gravity 218, a normal to the surface of the earth 216. Likewise, if the device electronic motion sensing device 200 is worn on the top of a shoe 220, positive X is in the direction of the toe 222 of the shoe 220, positive Y perpendicular to the shoe toe 222 but parallel to the ground 216 and Z in the opposite direction as the force of gravity 218, a normal to the surface of the earth 216. It should be appreciated by those skilled in the art that other orientations are also possible.

Referring to back to FIG. 1, the electronic motion sensing device 200 is described in the embodiment of the game communication assembly 20 and includes the components set forth above in a similar manner. As such, the componentry of the electronic motion sensing device 200 will not be repeated here. As shown in many of the Figures, the electronic motion sensing device 200 communicates with an external computing device 224. In many instances, the external computing device 224 is a smartphone with a output screen 226, although one skilled in the art should appreciate the external computing device 224 may take the form of any computing device with wireless communication capabilities and a screen 232. Additionally, data from the external computing device 224 can be wirelessly transmitted to the electronic motion sensing device 200 through the same variety of methods discussed above.

The electronic motion sensing device 200 can be attached to a hand 210, or other part of the body of the human 202, worn on a shoe 220, or embedded in a host device, such as a toy blaster 204, or an article of clothing, such as a shirt 234 or a hat (none shown). If the desire is to identify the position and orientation of the device 204, and not the human 202 or appendage thereof, the electronic motion sensing device 200 may be attached or designed into the device 204. One purpose of the invention is to calculate movements and positions of the electronic motion sensing device 200, and thereby the object 204, appendage (hand 210), or body (human 202) that is attached thereto.

Frame of Reference Determination:

One challenge of measuring motion, velocity or displacement of a moving body such as a hand or a foot is to determine a frame of reference that includes the device orientation of yaw, pitch roll, velocity and position. Resetting a frame of reference frequently can be important because errors or inaccuracies in the sensor data and calculations are accumulated over time and can lead to inaccurate results. Resetting the calculated motions values to a known frame of reference also resets errors, relative to that frame of reference, to zero. The invention sets a frame of reference based on a set of predefined sensor data patterns. These predefined sensor data patterns detect events such as a foot (not shown) or shoe 220 touching an immovable surface such as the ground 216 or floor when the invention is worn on the shoe 220 or affixed to a foot. When a foot touches a floor or ground and does not move relative to the floor or ground, a good frame of reference is known. In this state, for example, it is known that the foot is not in motion relative to the floor or ground 216. One can infer that the velocity and position of the foot is thus zero relative to the ground 216. It might also be advantageous to reset some or all of the angular parameters related to yaw, pitch and roll. The height of the shoe 220 is also effectively zero relative to ground 216, and therefore the position of height of the bottom of the shoe 220 is known. In one embodiment of this invention, it has been determined that one pattern of sensor data that works well for detection when a body 202 hits a rigid surface is an average of the absolute value of jerk or the derivative of acceleration over a fixed period of time, calculated according to Equation 1 set forth below:

$${J}_{avg} = 1 \text{/} N {\sum }_{i = t - N}^{t - 1} \vert {J}_{i} \vert \qquad Equation 1$$

Where:

J_{avg}=Absolute Jerk averaged over time “t”;

Jᵢ=Jerk Value (derivative of acceleration) at point i;

N=Number of samples to average; and

t=time in milliseconds.

Acceleration values used can be acceleration in the X, Y, and/or Z directions depending on the type of event that is desired to be detected. For example, it would be best to detect acceleration in the Y-direction for detecting the clapping of hands 210, whereas detecting acceleration in the Z-direction would be best for detecting a tap on the ground 216. It should be appreciated by those skilled in the art that combinations of directions are also possible.

To explain this technique an example is as follows. FIGS. 14a through 14d shows four graphs of data values plotted against time. In this example, the single motion detection in the Y-direction is given for simplicity. At time 236, the electronic motion sensing device 200 is at rest and all positions and velocities are set to zero. At time 238, accelerometer data 240 for the Y-direction from an accelerometer sensor 42 is detected to be greater than an at rest value. Integration of this accelerometer signal yields velocity 242. At time 238, velocity is calculated to be non-zero based on the integration of acceleration data 240. It should be noted that the velocity data 242 could also be integrated to yield displacement (not shown). Throughout this example, the absolute value of the derivative of acceleration in the Z-direction or up and down, i.e., jerk, is averaged over a set period of time, typically 100 ms. The average jerk data is show at 244. When the average jerk value reaches a predetermined threshold value at time 246, it is determined that an event, such as a shoe 230 hitting the ground 216 is detected and all velocities and displacement values being utilized by the electronic motion sensing device 200 and stored in memory 52 are reset to zero at the time 246.

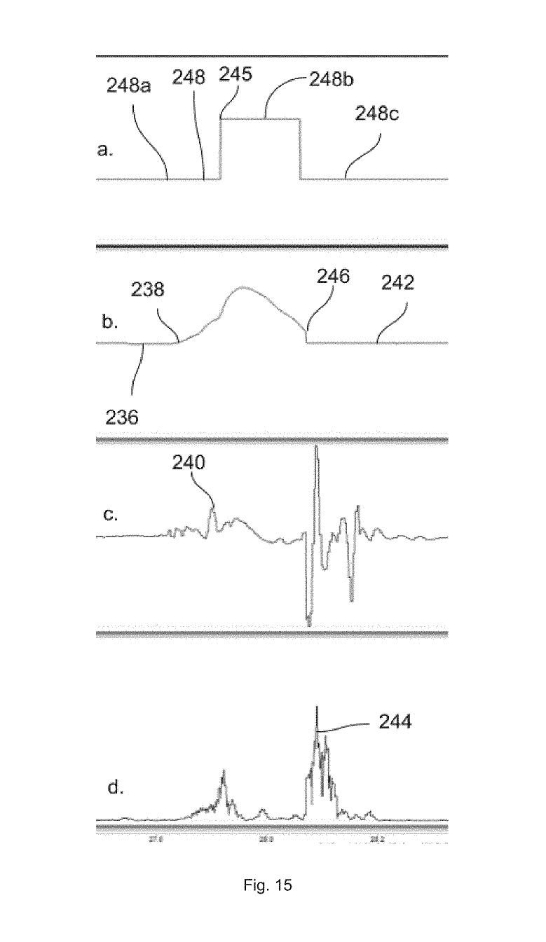

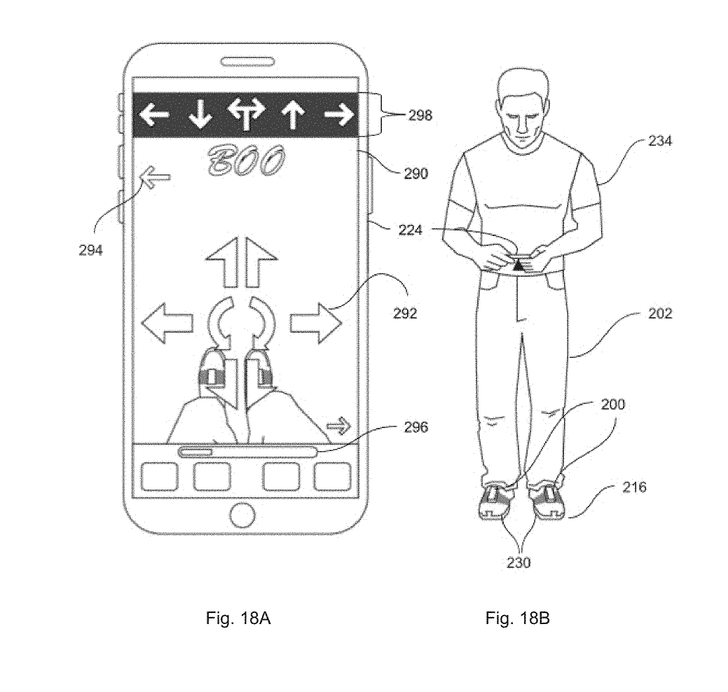

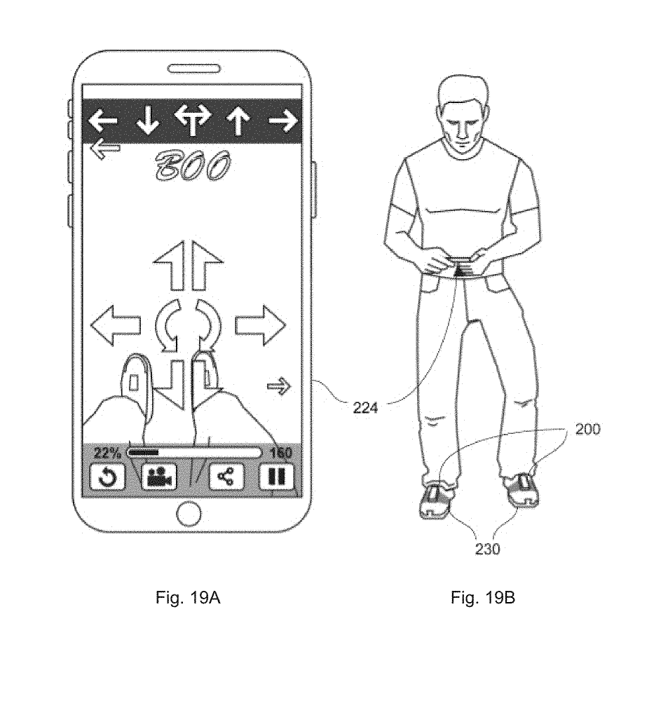

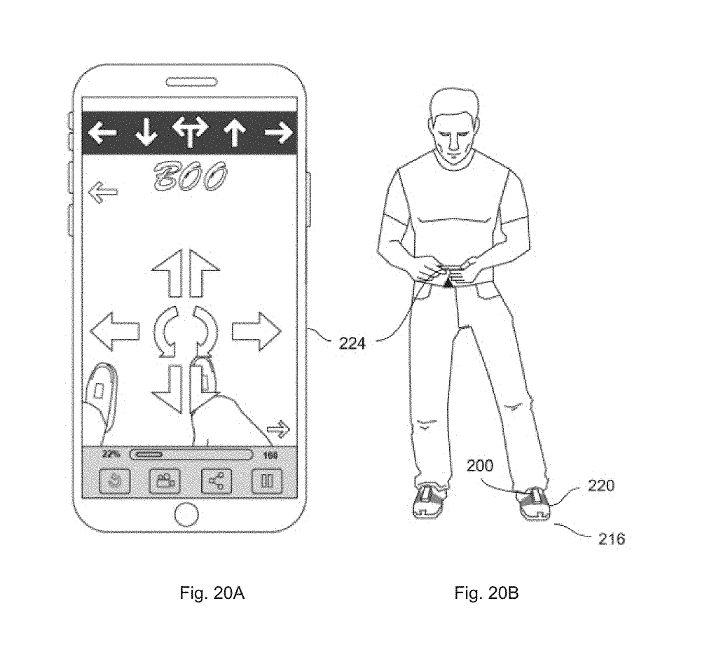

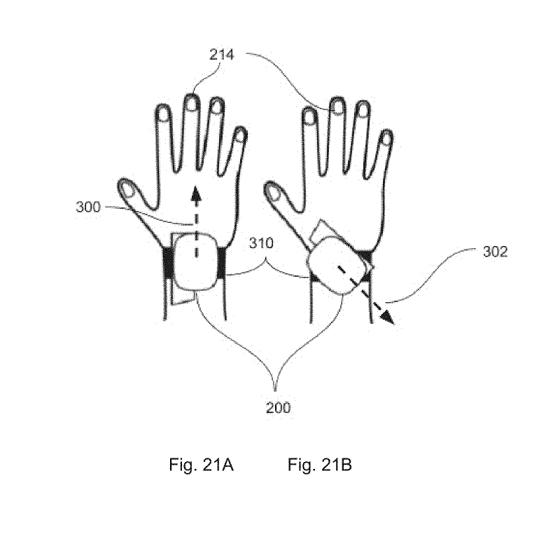

As an additional enhancement to this example, it is possible to modify the threshold values and data patterns used to detect events in real-time based on certain conditions. For example, a data stream 248 in FIG. 15 denotes a binary condition of non-move-left or move left 272. Referring to FIGS. 18a and 18b, in the case of a shoe 230, movement can only occur if the shoe has left the ground 216 or other stationary surface, such as the floor. The shoe 230 of a person 202 begins on the ground, represented by 248a and FIGS. 18a and 18b. Once the shoe 230 leaves the ground at 248b, as represented in FIGS. 19a and 19b, it is anticipated that it will return at 248c, some point in the future as represented in FIGS. 20a and 20b, regardless if the person is jumping, walking, running, standing, dancing or sitting. In anticipation of the shoe's 220 return to the ground 216, the threshold value or data pattern used in determining events to make the event determination either more or less sensitive based on the desired effect can be adjusted. This will be done automatically based on previous data or previous states. This logic can be applied to the hands 210 if the device is used in detecting the position of hands as input into a game or in a entertainment music system for creating some form of music or rhythm sounds. For hands 210, a reset event could be clapping two hands 210 together. Another example of a reset event is simply a sensed state of no rotation and the only acceleration is that of the component of gravity as is the case if the device is not moving or moving at a constant velocity. If there is zero acceleration sensed by the acceleration sensor 42, it could be inferred that the device is in a free fall. These are all possible event states were it could be beneficial to reset the frame of reference depending on application of the invention.

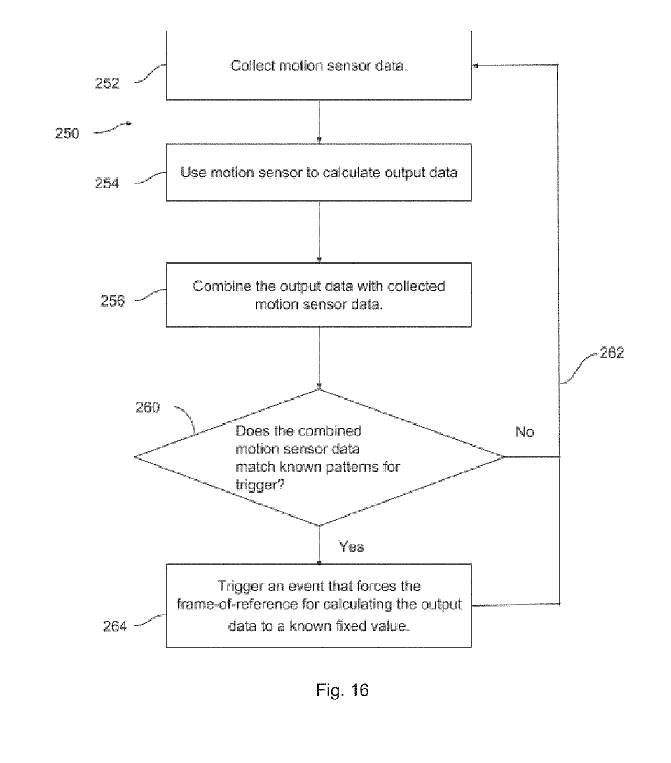

Referring to FIG. 16, a logic chart of one embodiment of the invention is generally indicated at 250. The method 250 calculates motion for the electronic motion sensing device 200 using motion data collected by a motion sensor(s) 42. The method begins by collecting the motion data using the motion sensor 42 at 252. With the motion data, output data is calculated at 254. The output data and the motion data are combined to create combined data at 256. It is then determined at 258 whether the combined data matches known patterns for a trigger event at 260. If the combined data does not match a trigger event, the method 250 loops back at 262 to collect more motion data at 252. If a trigger event is identified, the method 250 uses the trigger event to set the frame of reference of the movement of the electronic motion sensing device 200 to a known fixed value at 264. When the motion sensor data and calculated output data indicate that the device is at rest, e.g. when gyro values for angular velocity are at or near zero and the acceleration sensor indicates a cartesian vector magnitude of near 1G from gravity acting on the acceleration sensor, the angular direction of the 1G vector can be used to orient the frame of reference for X and Y being parallel to the earth's surface.

From the known frame of reference that was calculated at 264, a directional linear velocity, linear displacement, angular velocity and angular position can be calculated from the accelerometer sensor data and gyroscope sensor data, respectively, with common euler and quaternion algorithms well known in the art. From this frame of reference and starting with zero error, relative motion values for displacement, velocity, angular position, angular velocities and other values can be calculated.

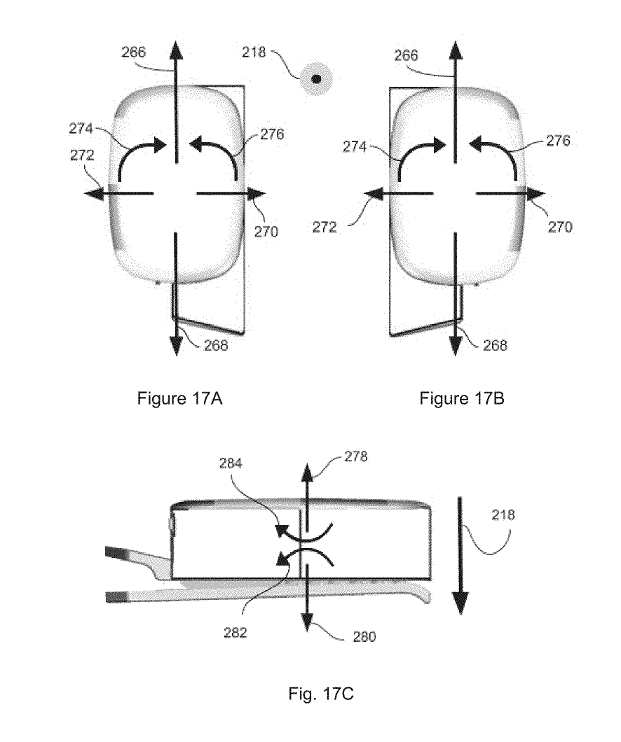

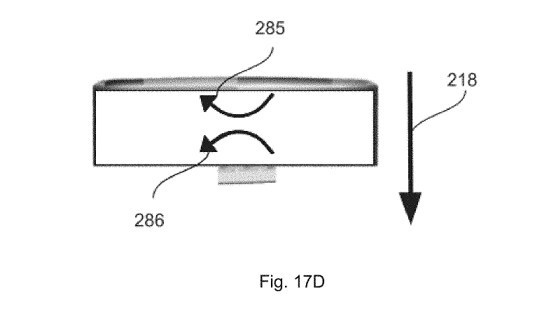

Referring to FIGS. 17a through 17d, applications that do not require exact values for motion, simplified binary values can be provided. For example, move forward 266, move backward 268, move right 270, move left 272, turn right 274, turn left 276, move up 278, move down 280, tilt back 282, tilt forward 284, tilt right 285, tilt left 286. The simplified values are often easier to use and understand for an application or game running on the external computing device 224 and can be transmitted with less communications bandwidth if that is an advantage for a specific purpose. The motion data values, simplified or non-simplified, can be used in games, other entertainment purposes such as dance rhythm judgement or in medical applications to monitor body motions for diagnostic or other purposes. For motions that require a relative direction from the earth, gravity is used as the reference and is denoted at 218.

As an example application of the invention consider a dance game in FIGS. 18a and 18b. In this game, there is a player or user 202 that is both holding the external computing device 224, in this case a mobile smart device, and wearing an embodiment of the electronic motion sensing device 200 on the top of each shoe 230. The user interface 290 of the external computing device 224 is shown. The dance game 292 is shown running on the user interface 290 of the external computing device 224. In this game, there are scrolling arrows 294 that move toward a top of the user interface 290 in rhythm and beat to a user selected song 296 supported by the dance game that is played on the external computing device 224. The object of the game is for the user 202 to move his or her feet in the direction of the scrolling arrows 294 and tap the floor 216 with the foot/shoe 220 at the time when the scrolling arrows 294 are in a scoring area 298. The timing, position and direction of the scrolling arrows 294 are designed so that the user 202 performs a fun and entertaining dance to the rhythm and beat of the song that is being played on the external computing device 224, so long as the movement and tap of the feet are performed in accordance with the scoring criteria. It should be noted that the example embodiment of the electronic motion sensing device 200 enables this game by providing a method for determining the motion of the example embodiment affixed to the feet, and transmitting this motion information to the external computing device 224 where scoring can occur. Events such as the scoring tap, that is when the foot hits the floor ideally at the same time arrows 294 are in the scoring region 298, are also optionally transmitted to the external computing device 224. When the foot 230 taps the floor 216, the electronic motion sensing device 200 detects a reset event and the frame of reference is reset to zero along with any error in the motion data, and the next motion data is calculated from this new frame of reference.

The position and state of the invention in FIG. 18a and FIG. 18b are represented by time 248a in FIG. 15. In this state, the user's shoes 230 are at rest and on the floor 216. FIG. 18a and FIG. 18b represent the a slightly later place in time between 248a and 248c of FIG. 15. More specifically, FIGS. 18a and 18b represent time 248b or the transition states between 248b and 248a and/or 248c. In this state, the example embodiment of the invention electronic motion sensing device 200 along with the shoe 230 (or more generally any body part) desired to be measured is in motion and the velocities, displacements, angles and other motion information are calculated and optionally transmitted in real-time to the external computing device 224 for scoring purposes. In this example, the move left 272 motion from FIG. 19a, FIG. 19b and also represented at 245 in FIG. 15a, is sent to the external computing device 224.

FIGS. 20a and 20b represent time 248c in FIG. 15a. The player's shoe 220 touches the ground 216, which causes a trigger event to occur. When the trigger event occurs, the electronic motion sensing device 200 detects the trigger event through the aforementioned method and resets the frame of reference and transmits the event to the external computing device 224, which may use that information for scoring purposes.

Referring back to FIG. 14, wherein like primed reference characters represent similar elements as discussed above, another embodiment of the electronic motion sensing device 200′ is housed within the host device 204′. In this embodiment, the host device 204′ is shaped as a gun or blaster, but modified to be capable of holding the external computing device 224. In this embodiment, the motion sensors and computing devices are embedded into the host device 204′. The motion data that defines an event that triggers a new frame of reference for the host device 204′ held in the hands 210 is typically different than the motion data that triggers a new frame of reference for the shoes 220. In the case of the embodiment of the invention being held in or worn on the hand 210, a trigger condition could be that of motion data representing a steady state or still condition. If it can be determined that the electronic motion sensing device 200′ is in steady state or still condition meaning not rotating and the only acceleration detected is with a magnitude from the component of gravity, then the gravity component of acceleration, e.g. straight into the earth, can be used to set the pitch and roll to that perpendicular to earth so that the X and Y axes of the frame of reference are parallel to the ground.

The electronic motion sensing device 200′ has the ability to communicate to the external computing device 224 executing a game. Many games for mobile devices use standard gamepad controller profiles or human interface device HID profiles as defined by Apple and Android documentation. The present embodiment of the invention provides for its output values, simplified or non-simplified, to be mapped into standard input for use with many games not specifically designed to represent a gun or blaster. It would be possible to map the simplified output values to the various buttons and switches on the gamepad controllers so that the game responds to the desired input on the invention in the same way as if the player was using a standard controller.

Device Orientation Determination:

In order to calculate directional movement and position information from a portable or wearable electronic device with a built in motion sensor like an accelerometer, it is necessary to know the sensor's orientation from a frame of reference. When using a handheld Nintendo Wii handheld controller or Switch handheld controller that include hand motion measurement functionality, the orientation position of the built-in accelerometer X, Y, and Z is fixed based on the housing of the device. By virtue of holding the device in the proper way, the orientation of the sensors is known relative to the user's hand or arm. If the device is not held correct, the frame of reference is not correct, hand gestures and movement are not calculated properly and the device will not yield desirable results.

To illustrate why it may be desirable calculate the orientation of the electronic motion sensing device 200 embedded in a device and not always assume the device is held or worn correctly, consider FIGS. 21a and 21b. We have an embodiment of the electronic motion sensing device 200 where it is assumed that the electronic motion sensing device 200 is worn on the wrist 310 so that in the frame of reference, the positive X direction of the sensor points in the direction of fingers 214. It is quite conceivable that it may not be possible for a user 202 to be able to attach the electronic motion sensing device 200 correctly. If the electronic motion sensing device 200 is not worn in this orientation, then incorrect movement calculations will result. In both of FIGS. 20a and 20b, the electronic motion sensing device 200 is being worn on the back of the wrists 310. An arrow 300 represents the direction of the positive X direction of a accelerometer sensor embedded in the electronic motion sensing device 200. The arrow 300 also shows the positive X direction of an accelerometer sensor embedded in the device 200. In FIG. 20a, positive X is in the direction of the fingers 214, while in FIG. 20b, positive X is in a direction other than the general direction of the fingers 214. Hand movement forward with the device in orientation represented by arrow 302 will yield very different results than hand movement forward with the device orientation represented by arrow 300.

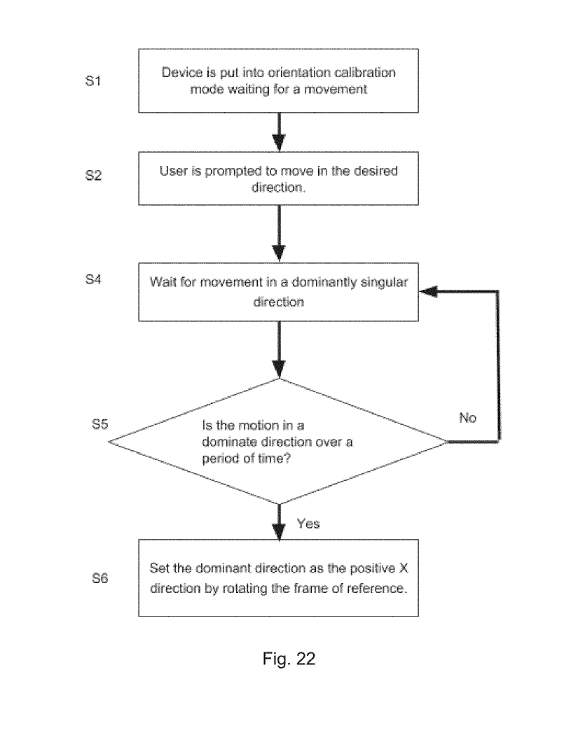

The inventive method determines the orientation of a sensor in a device attached to a movable body 202. An example of this method consists of the following steps in FIG. 22. At step S1 the device is put into a orientation calculation mode. At step S2 the user is prompted through a user interface such as the screen of a mobile smart device that is communicating to the present invention through a standard method such as WiFi or BLE to move the device in a known direction. For example, if the device is worn on the hand, the user is prompted to punch directly forward or if the device is worn on the foot, a step directly forward. At step S3 the device constantly measures motion sensor data and waits until it senses movement in a dominate and singular direction or a period of time. If, at S5, the device determines that there was a movement and the movement direction did not change significantly over a period of time, the frame of reference for movement data of the device is adjusted at S6 so that the positive X direction points in the same direction as that of the direction of the movement.

Image Transposition:

When playing an electronic game or using an app in some type of entertainment or competitive scenario, having others, observing, sharing or socially interacting with the players in the game enhances the experience. Many professional eSports and other video game players often record or stream video of themselves and their game play screen overlay so that the information can be shared on social media channels or video sharing sites like YouTube, Twitch and others. Console game systems such as Microsoft XBox, Sony Playstation or personal computer gaming systems offer features like video recording cameras and other equipment for players to record or stream game play of players along with the video of the actual player in the game so that remote observer's can view both the player and the game play on the observer's computing device. It is a common practice for players of video games to video record the game play with themselves overlayed on the same video for sharing on media channels like YouTube, Facebook, Instagram, Snapchat and so on. In this scenario, it is the player or on the players computing device, not the observer or the observer's computing device, that combines the video of the game with that of the video of the player.

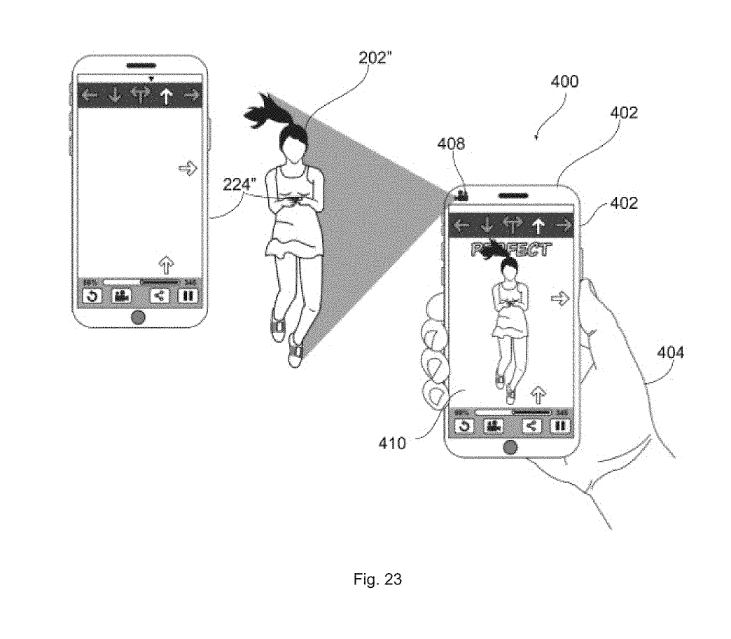

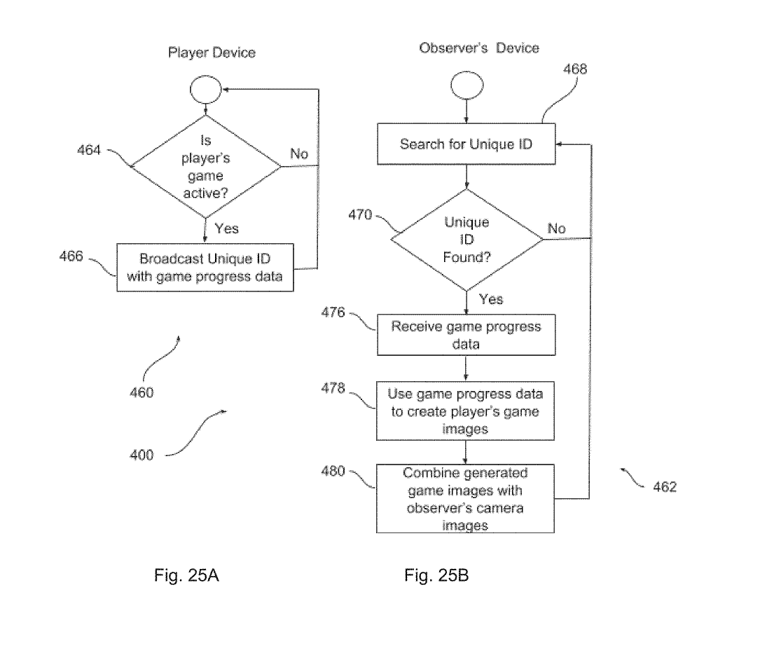

One aspect that makes hand held device, virtual reality systems or mobile game play less social is that it can be difficult for observers to see the game or app being used along with the user or player of the game. Referring to FIG. 23, wherein like double primed reference characters represent similar elements to those discussed above, this inventive method 400 (FIGS. 25a and 25b) provides a method for a second external computing device 402 of an observer (graphically represented by a hand) 404 to identify a player 202″ in the physical vicinity of the observer 404 and view gameplay of the player 202″ along with the player 202″ on the observer's second external computing device 402 so that the observer 404 can see the game action on the computing device screen 406 and also optionally participate in the gameplay.

Consider the observer 404 of a game player 202″ playing a game on the external computing device 224″. The observer 404 or observers 404 of the player 202″ could use the camera (graphically represented by movie camera icon) 408 built therein to record video or take pictures of the player 202″ and share these videos and pictures on video outlets such as YouTube or through social media channels, such as Snapchat, Facebook, LinkedIn and the like. However, existing art only enables the player 202″ to be seen or recorded with a camera (not shown) on the external computing device 224″ of the player 202″. The invention adds the ability to combine video or pictures of the player 202″ from a camera 408 on the second external computing device 402 with that of the game being played by the player 202″ on the screen 406 of the second external computing device 402, so that the observer 404 can see both the game play along with the player 202″ time synchronized together.

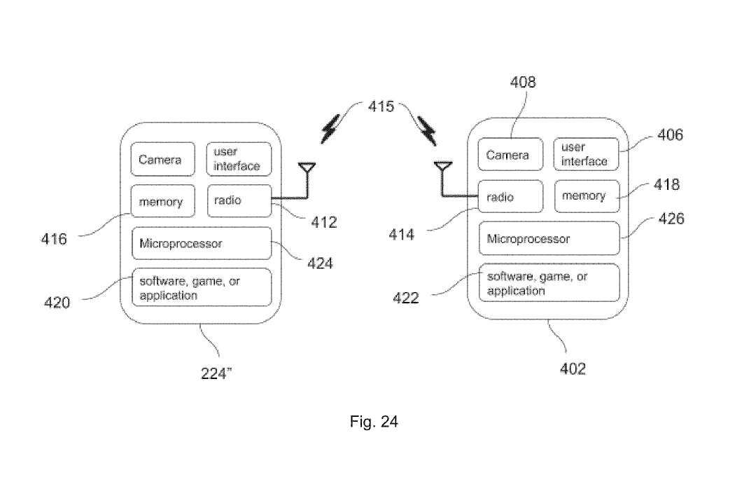

As an explanation of an example embodiment of the second inventive method 400, consider FIG. 24. There is minimally the external computing device 224″ such as an Apple iPhone, iPad, Android Phone or tablet, and second external computing device 402 such as an Apple iPhone, iPad, Android Phone or tablet. Both devices 224″, 402 are equipped with radios 412, 414 capable of data transmission over a wireless network, graphically represented by electric bolt 415, as are common on mobile devices. Example wireless networks include, WiFi, Bluetooth, BLE, Cellular 4G or 5G etc, and ANT. Both devices 224″, 402 are also equipped with memory 416, 418 used to store software, a game or an application 420, 422 running in a microcontroller 424, 426. The microcontroller 426 controls the camera 408. When running a game, software or application 420, it is possible to broadcast an identifier along with game progress data on a wireless network so that the second external computing device(s) 402 can receive this data using the radio 414. The software 422 on the observer's second external computing device 406 can receive the identifier and receive game progress data sent by the software 420 on the external computing device 224″ of the player 202″, which will be received by the software 422 on the second external computing device(s) 402. Using this communications it is possible for the player's game information to be shared on the observer's second external computing device 402. This game progress information is used to create game progress images on the observer's user interface, presumably the screen 406 of the second external computing device 402. The images graphically represented on the screen 232 of the external computing device 224″ can be combined with images from the observer's camera 408 to yield the resulting image 410 in FIG. 23.

In the explanation so far, there has been only one player 202, 202″. If there are multiple players, a method is needed to determine which player's device 14 the observer's second external computing device 402 should connect to. Generally, the observer 404 will point the camera 408 the player 202, 202″ that he or she desires to observe. This leads to the possibility that the software 422 on the observer's second external computing device 402 could detect the correct transmitted identifier from many if the identifier was associated with some type of visual cue. This visual cue could be a number worn on the shirt of the player 202, 202″ or a visual cue from an electric device equipped with an light emitting diode transmitting a visual light pattern worn by the player. Another solution would be for the identifier transmitted by the player's device 224, 224″ to be associated with the player's name or other identifying information. The software 422 could present the identifying information from a plurality of players on the observer's device user interface 406 so that the observer 404 could select the desired player 224, 224″.

Referring back to FIG. 25a and FIG. 25b, the second inventive method is generally shown at 400. Two subroutines, generally indicated at 460 and 462, represent the subroutines for the player 224, 224″ and the observer 404, respectively. The player subroutine 460 begins with identifying whether a game is active or not at 464. If so, a unique player ID and game progress data are broadcast at 466. This player subroutine 460 loops indefinitely to constantly update game progress data broadcasts.

The observer subroutine 462 begins with searching for unique player IDs at 468. It is determined at 470 whether a unique player ID has been found at 468. If not, the observer subroutine 462 loops back at 462 and continues to search. If a unique player ID is found, the observer subroutine 462 collects the game progress data at 476. The game progress data is used at 478 to create an image of the progress of the game on the screen 406 of the second external computing device 402. The game progress data is combined at 480 with images generated by the camera 408 to create a combined game progress image that includes the images of the game as seen by the player 224, 224″ and the images captured by the camera 408. Once the combined game progress image is created, the observer subroutine 468 loops back and searches for a unique player ID at 468.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for an electronic motion sensing device to calculate motion using motion data collected by a motion sensor, the method comprising the steps of:
collecting the motion data using the motion sensor;
calculating output data using the motion data;
combining the output data and the motion data to create combined data;
comparing the combined data to known data patterns;
determining an occurrence of a trigger event; and
setting a frame of reference for the step of calculating the output data to be used by the electronic motion sensing device after the occurrence of the trigger event.

2. A method as set forth in claim 1 whereby the known patterns includes a jerk pattern being the average value of the absolute value of jerk over a set period of time optionally in one or more of the X, Y and Z directions of a cartesian space.

3. A method as set forth in claim 1 including calculating linear motion data and angular motion data from a sensor input or plurality of sensor inputs based on the frame of reference.

4. A method as set forth in claim 3 including using simplified binary values for the linear motion data and the angular motion data of move forward, move backward, move right, move left, turn right, turn left, move up, move down, tilt back, tilt forward, tilt right, tilt left.

5. A method as set forth in claim 4 including mapping the simplified binary values and calculated motion data into common input controllers of existing games and software running on a host computer.

6. A method as set forth in claim 1 including reiterating the step of setting a frame of reference after every occurrence of the trigger event.

7. A method as set forth in claim 6 including establishing a threshold used in determining the occurrence of the trigger event.

8. A method as set forth in claim 7 wherein the step of establishing a threshold includes the step of adjusting a sensitivity of the threshold based on a desired preference.

9. A method as set forth in claim 8 wherein the threshold is a value.

10. A method as set forth in claim 8 wherein the threshold is a data pattern.

11. A method to generate a video of a screen output of a game on a first external computing device and a video feed from a camera of a second external computing device, the method comprising the steps of:
determining whether a game is being played on the first external computing device;
broadcasting a unique ID data and game progress data out and away from the first external computing device;
searching for unique ID data using the second external computing device;
activating the camera on the second external computing device;
capturing video using the camera; and
reading the game progress data to create an image on the second external computing device similar to that which is being played on the first external computing device; and
overlaying the video captured by the camera over the image of the game being played on the first external computing device to generate a composite video.

12. A method as set forth in claim 11 including the step of storing the composite video in memory of the second external computing device.

13. A method as set forth in claim 11 including the step of streaming the composite video through a social media channel.

14. A method to determine the orientation of a sensor in a device relative to a host body, the method comprising the steps of:
putting the device into sensor orientation calibration mode;
prompting the user to move the device in a singular direction;
detecting a dominate singular direction of motion; and
orienting a frame of reference for the sensor in the dominate singular direction of motion detected.
